(19) United States
(12) Patent Application Publication
(10) Pub. No.: US 2007/0145793 A1
(43) Pub. Date: Jun. 28, 2007

(54) SADDLER AND ITS FRAME

(76) Inventor: Ying-Chieh Su, Kaohsiung City (TW)

Correspondence Address: Venable LLP;Raymond J. Ho, 575 7th Street NW, Washington, DC, 20004-1601, US

(21) Appl. No.: 11/459,018

(22) Filed: Jul. 20, 2006

(30) Foreign Application Priority Data
Dec. 27, 2005 (TW) 94146803
Jun. 28, 2006 (TW) 95123433

(51) Int. Cl. B62J 1/00

(52) U.S. Cl. 297/195.1

(57) ABSTRACT

The invented saddle comprises a support, a wing part fixed to its one end, a nose part fixed to the other end and a flexible material assembly connecting the wing part and the nose part. The wing part provides a first surface of a predetermined shape. The nose part provides a second surface and is disconnected with the wing part. The flexible material assembly defines a surface connecting the first surface and the second surface. The invention also discloses the frame of the invented saddle.

### FIELD OF THE INVENTION

The present invention relates to a novel saddle and its saddle, especially to a sadder that is suited for the recreation devices, the transportation devices or other devices for riding and its frame.

### BACKGROUND OF THE INVENTION

The saddle is a useful component in all kinds of recreation devices, wheeled devices and other devices for riding. The most popular usage of the saddle is in the case of a bicycle.

The conventional saddle for bicycle is positioned on the frame of the bicycle. Its major functions are to support the weight of the rider and to allow the rider to control the movement of the bicycle. The conventional bicycle saddles are so designed that, when the rider is riding the bicycle the saddle would bring great pressures to the perineum of the rider. Such pressures would impact the blood supply and the nerve conduction of the penis, which have the likelihood of causing the sexual malfunctions to the rider.

In the conventional saddle, the wing part of the saddle supports about 80% of the weight of the rider, while the nose part of the saddle supports the rest 20% of the weight but brings pressures to the perineum of the rider. Saddles without the nose part are thus invented. The saddles without the nose part effectively releases the riders from suffering from the pressures brought to their perineum by the nose part. They however reduced the controllability of the bicycle, due to the omission of the nose part. When riding on a saddle without the nose part, the rider is just like riding on a ball, without the sense of safety. As a result, very few people would choose to use the saddle without the nose part.

Therefore, it is necessary to provide a novel saddle for wheeled devices and recreation devices or the like to provide sufficient supports to the weight of the rider and to provide necessary controllability of the devices.

It is also necessary to provide a saddle that does not bring pressures or shocks to the perineum of the rider.

### OBJECTIVES OF THE INVENTION

The objective of this invention is to provide a novel saddle and its frame.

Another objective of this invention is to provide a saddle and its frame that provide sufficient supports of the weight of the rider and proper controllability of the device that uses the saddle.

Another objective of this invention is to provide a saddle and its frame that reduces the pressure and shocks brought to the perineum of the rider.

### SUMMARY OF THE INVENTION

According to the present invention, a novel saddle and its frame are provided. The saddle of this invention comprises: A support, a wing part connected to one end of the support, a nose part connected to the other end of the support and a flexible material assembly. The wing part defines a first surface in predetermined form and shape and supports the weight of the rider. The nose part defines a second surface. A hollowed part is provided between the wing part and the nose part. The flexible material assemble connects the wing part and the nose part and form a connecting surface between the first surface and the second surface. The flexible material assembly may envelop said first surface and/or said second surface and may be fixed to the support.

The saddle with the above-mentioned structure provides continuous and close contacts of the connecting surface and the perineum of the rider. The connecting surface of the saddle supports about 20% of the weight of the rider. Since the connecting surface forms a suspending surface to support the rider and provides the maximum contacting area with the perineum of the rider, pressures and shocks brought to the perineum of the rider may thus be effectively absorbed and distributed.

These and other objectives and advantages of this invention may be clearly understood from the detailed description by referring to the following drawings.

### BRIEF DESCRIPTION OF THE DRAWINGS

FIG. 1 illustrates the structure of the frame of the saddle of the invention.

FIG. 2 illustrates the structure of the saddle of the invention.

### DETAILED DESCRIPTION OF THE INVENTION

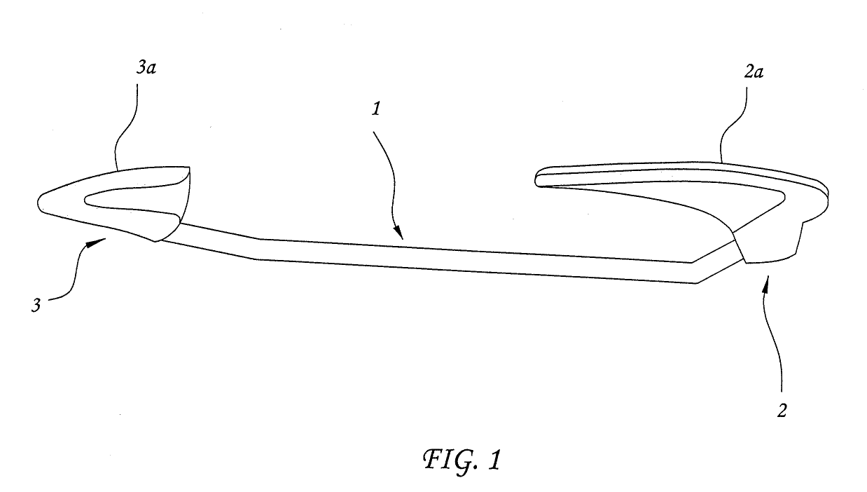

FIG. 1 illustrates the structure of the frame of the saddle of the invention. As shown in this figure, the frame of saddle of this invention comprises a support 1, a wing part 2 and a nose part 3. The support 1 is made from a stiff material, in the shape of a rode, a plate or a block, or any particular shapes. Generally speaking, in order to effectively support the weight of the rider, it is preferable to make the two ends of the support 1 ascended. Materials suited in the preparation of the support 1 include any material that is stiff and is able to support the weight of the rider. Examples are: metal, such as stainless steel, aluminum etc., plastics, such as fiber glass, acrylic etc., carbon fibers, ceramics, glass or other composite materials.

The wing part 2 is fixed to one end of the support 1 and the nose part 3 is fixed to the other end of the support 1. The wing part 2 forms a first surface 2a at its top side, to be connected with the gluteus of the rider and to support about 80% of the weight of the rider. The nose part 3 forms a second surface 2a at its top side and forms a hollowed part (or a disconnected part) between the second surface 2a and the first surface 1a. The shape of the first surface 2a and the second surface 3a is not limited to any particular shape. It may be a planar, radial, spherical, or any particular shape with concaved and/or convex parts, or their combinations. It is not intended to limit the scope of this invention but the first surface 2a is preferably provided with an ascended central part and two lower parts at its sides, so to support the gluteus of the rider. The material of the nose part 3 and the wing part 2 is not particularly limited. It may be metal, plastic, resin, carbon fiber, ceramic, glass, wood or any natural, artificial or composite material. It may be the combination or composition of several kinds of material. If necessary, an elastic layer, a protection layer and/or a decoration layer may be used in the wing part 2 and the nose part 3. The wing part 2 and the nose part 3 may be prepared in any conventional method. As to the method of the connection of the wing part 2 and the nose part 3 with the support 1, any commercially available method may apply. Examples include coupling, soldering, screw connection or even one-piece casting.

The frame as described above may be used to produce saddles for desired purposes.

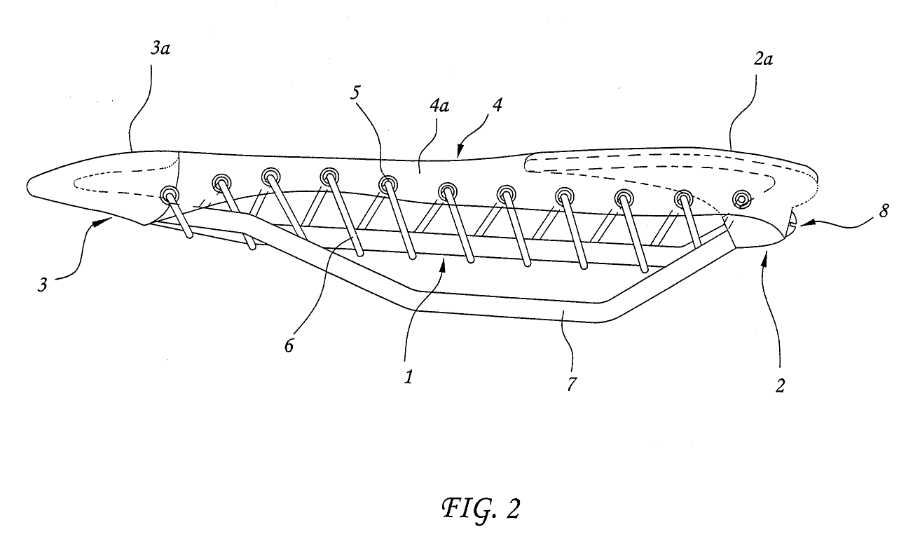

The saddle of the invention will be described in details in the followings. FIG. 2 illustrates the structure of the saddle of the present invention. In FIG. 2, components that are the same as those in FIG. 1 are labeled with the same numerals.

As shown in FIG. 2, the saddle of this invention has the frame as shown in FIG. 1 which therefore comprises a support 1, a wing part 2 and a nose part 3. The shape, structure, material and the connections of the support 1, the wing part 2 and the nose part 3 are already described above. FIG. 2 shows that the saddle further comprises a flexible material assembly 4. The flexible material assembly 4 connects the wing part 2 and the nose part 3 and forms a connecting surface 4a between them. The flexible material assembly 4 as shown in FIG. 2 covers the first surface 2a of the wing part 2a and the second surface 3a of the nose part 3. Therefore, the shape of the connecting surface 4a is defined by the edges of the first surface 2a and the second surface 3a. In another embodiment of this invention, the flexible material assembly 4 covers the first surface 2a but not the second surface 3a. In other embodiments, the flexible material assembly 4 covers neither the first surface 2a nor the second surface 3a.

The flexible material assembly 4 comprises at least a flexible material layer. It may also be a flexible layer made of any flexible material. Suited materials for the flexible material assembly 4 include: fabrics, plastics, resin, leather or metal. If the material is a fabric, it may contain artificial fibers or natural fibers. It may also be any woven or non-woven material of any artificial, natural or composite material. Surface processing or foaming technologies may be applied to the flexible material assembly 4 to produce a protection layer or a cushion layer. If the flexible material assembly 4 is made from metal materials, it may be made in foils, a net, panels or spring coils. It is also possible to prepare the flexible material assembly 4 with a material with porous structure. Additional protection layer, cushion layer and/or decoration layer may be prepared on the surface of the flexible material assembly 4 to make the saddle more comfortable, beautiful and endurable.

The flexible material assembly 4 may be fixed to the wing part 2, the nose part 3 and the support 1 in any applicable method. In the embodiment as shown in FIG. 2, the flexible material assembly 4 is provided with a plurality of holes 5 and is fixed to the support 1 by the extended rope 6 continuously. The rope 6 is preferably a tenable flexible material, such as metal threads, leather or a rope bundled by multiple strands. Other material that may fix the assembly 4 flexibly to the support 1 may also be used in this invention. The flexible material assembly 4 may be fixed to the support 1 by any applicable means to form a flexible connecting surface 4a. In FIG. 2 a connecting rode 7 is shown. The connecting rode 7 serves to connect the rope 6. The connecting rode 7 may be omitted, if the rope 6 is connected to the support 1. A screw 8 is optionally used to fix the flexible material assembly 4 to the wing part 2.

The saddle of this invention may be fixed to the frame of a wheeled device, recreation device or the like, such as a bicycle, and function as the saddle of the device. When the rider rides the device sitting on the saddle, about 80% of the weight of the rider are supported by the wing part 2 and the rest by the connecting surface 4a. Within the 80% of body weight, the wing part 2 shares about 70% of the weight and the connecting surface shares the rest 30%. Because the connecting surface 4a forms a suspending supporting surface and contacts with the perineum of the rider in the maximum area, pressures and shocks brought to the perineum of the rider may be effectively distributed and absorbed. Undesired pressures and shocks to the perineum of the rider may thus be avoided or reduced. The connecting surface 4a provides high controllability to the device being ridden. The technical problems of the conventional art are effectively solved.

As the present invention has been shown and described with reference to preferred embodiments thereof, those skilled in the art will recognize that the above and other changes may be made therein without departing from the spirit and scope of the invention.

What is claimed is:

1. The frame of a saddle comprising a support, a wing part fixed to one end of said support and a nose part fixed to another end of said support; wherein said wing part provides a first surface with a predetermine shape to support weight of a rider, wherein said nose part provides a second surface and wherein a hollowed part is formed between said wing part and said nose part.

2. The frame of saddle according to claim 1, wherein said support forms slightly ascended parts at its ends in its longitudinal direction.

3. The frame of saddle according to claim 1, wherein said first surface has an ascended central part and two lower side parts.

4. The frame of saddle according to claim 1, wherein at least one of an elastic layer, a protection layer and a decoration layer is provided on said first surface.

5. The frame of saddle according to claim 1, wherein at least one of an elastic layer, a protection layer and a decoration layer is provided on said second surface.

6. A saddle, comprising a support, a wing part fixed to one end of said support, a nose part fixed to another end of said support and a flexible material assembly; wherein said wing part provides a first surface with a predetermine shape to support weight of a rider, wherein said nose part provides a second surface, wherein a hollowed part is formed between said wing part and said nose part and wherein said flexible material assembly forms a connecting surface between said first surface and said second surface.

7. The saddle according to claim 6, wherein said support forms slightly ascended parts at its ends in its longitudinal direction.

8. The saddle according to claim 6, wherein said first surface has an ascended central part and two lower side parts.

9. The saddle according to claim 6, wherein at least one of an elastic layer, a protection layer and a decoration layer is provided on said first surface.

10. The saddle according to claim 6, wherein at least one of an elastic layer, a protection layer and a decoration layer is provided on said second surface.

11. The saddle according to claim 6, wherein said flexible material assembly covers at least one of said first surface and said second surface.

12. The saddle according to claim 6, wherein said flexible material assembly comprises a flexible material layer.

13. The saddle according to claim 6, wherein at least one of a protection layer and a cushion layer.

14. The saddle according to claim 6, wherein said flexible material assembly comprises a metal material in the shape of foils, a net, panels or spring coils.

15. The saddle according to claim 6, wherein said flexible material assembly forms a plurality of holes at its edges and is fixed to said support with ropes through said plurality of holes.
